(19) United States
(12) Patent Application Publication
(10) Pub. No.: US 2001/0017200 A1
(43) Pub. Date: Aug. 30, 2001

(54) Plate-fin type heat exchanger

(75) Inventors: Koji Noishiki, Takasago-shi (JP); Shuhei Natani, Takasago-shi (JP)

Correspondence Address: REED SMITH HAZEL & THOMAS, 3110 Fairview Park Drive, Suite 1400, Falls Church, VA, 22042, US

(73) Assignee: Kabushiki Kaisha Kobe Seiko Sho

(21) Appl. No.: 09/778,086

(22) Filed: Feb. 7, 2001

(30) Foreign Application Priority Data
Feb. 9, 2000 (JP) 2000-031727

(51) Int. Cl. F28D 1/00; F28F 9/02; F28F 9/04; B23P 15/26; B21D 51/38

(52) U.S. Cl. 165/149; 165/173; 165/175; 165/178; 29/890.052

(57) ABSTRACT

One end sides of two sets of pressed-type headers, which have been molded by an existing press, are cut off, respectively, the cut-off portions of thus obtained one-side-cut-off headers are abutted together and are welded to each other, and a nozzle is welded to the position of a welded portion. With this construction, a large header, which is larger than the pressed-type header, can be manufactured, and the use of which permits a large plate-fin type heat exchanger, that can be used at high pressure, to be manufactured.

### BACKGROUND OF THE INVENTION

1. Field of the Invention

The present invention relates to a plate-fin type heat exchanger, and more specifically, to the technical field of a large plate-fin type heat exchanger capable of being used at high pressure.

2. Description of the Related Art

Plate-fin type heat exchangers are used to exchange the heat of a fluid in, for example, the processing of natural gases and in cryogenic service. The plate-fin type heat exchanger is typically constructed as shown FIG. 3 which is an overall perspective view of it and from FIGS. 4 and 5 which are perspective views of a header of it. Note that FIG. 4 shows an orange-peel-shaped (petal-shaped) welded-type header of the plate-fin type heat exchanger, and FIG. 5 shows a pressed-type header of the plate-fin type heat exchanger.

First, the general outlines of the typical plate-fin type heat exchanger denoted by reference numeral 1 will be described with reference to FIG. 3. A typical plate-fin type heat exchanger 1 includes a core 2 for carrying out heat exchange. The core 2 is constructed such that the upper and lower apexes of plate-fins (not shown), which are formed in a wave shape, are brazed to the confronting surfaces of partitions (not shown) and the openings of the partitions at both the ends thereof in a width direction are closed with side bars (not shown). Then, a header 3 having a nozzle 4, to which various pipes are to be connected at the extreme end thereof, is welded to each end of the core 2 in a lengthwise direction to supply fluid into and out of the core 2.

Incidentally, in a plate-fin type heat exchanger for processing a multiplicity of fluids, various types of constructions are employed as necessary, although not shown, such as a combination of a plurality of laminated cores, a core having headers mounted on the ends thereof in a width direction in addition to a lengthwise direction, and the like. Further, the nozzle is not always welded to the header but may be welded to necessary portions in accordance with a method for processing a fluid.

For example, headers as shown in FIGS. 4 and 5 are conventionally employed as the header 3 of the plate-fin type heat exchanger. That is, a header according to a conventional example 1 shown in FIG. 4 is an orange-peel-welded-type header 3w that is composed of a trough-shaped plate main body 31 having a nozzle 4 welded to the apex thereof and end plates 32 welded to both the openings of the trough-shaped plate main body 31 in a lengthwise direction (at four positions at the corners thereof). Further, a header according to a conventional example 2 shown in FIG. 5 is a pressed-type header 3p and is composed of a trough-shaped plate main body 31 and end plates 32 that are molded integrally by a press.

When it is assumed that the welded-type header 3w according to the conventional example 1 shown in FIG. 4 and the pressed-type header 3p according to the conventional example 2 shown in FIG. 5 have the same shape, size, and wall thickness, the pressure resistance, reliability, and cost efficiency of the header 3p are superior to those of the header 3w. One reason the pressed-type header 3p is superior to the welded-type header 3w in the pressure resistance and reliability is that it does not have any welded portion, and one reason it is superior to the welded-type header 3w in cost efficiency is that it can be produced in volume by the same press mold.

As is known well, the needs of users for plate-fin type heat exchangers which can withstand higher pressure have recently increased. They are required to increase a wall thickness of a header when they are used at high pressure. However, the employment of the welded-type header according to the conventional example 1 shown FIG. 4 is disadvantageous in cost because an increase in the wall thickness of the header makes it more difficult to weld the header, in addition to that, it is inherently difficult to weld the end plates thereof.

In contrast, the pressed-type header of the conventional example 2 shown in FIG. 5 cannot be employed in a large plate-fin type heat exchanger because the length of it is restricted by the capacity of existing presses. That is, the pressed header, which is superior to the welded header in pressure resistance, cannot be employed in the larger plate-fin type heat exchanger that is used at high pressure, and actually, the welded-type header cannot help being employed in the large plate-fin type heat exchanger regardless of whether it is inferior to the pressed-type header in cost performance.

It should be noted that there is available a header that is constructed such that both the ends, which are formed in a vertical cross-sectional shape, of a trough-shaped plate main body, are closed with semicircular plates, this type of the header is not described here because it can be used only at low pressure.

### SUMMARY OF THE INVENTION

Accordingly, it is an object of the present invention to provide a large plate-fin type heat exchanger capable of being used at high pressure without the need of employing a welded-type header.

The inventors have completed this invention by finding that a longer large header, which is superior to a welded-type header in pressure resistance, can be easily manufactured by cutting off a plurality of pressed-type headers according to the conventional example 2 of FIG. 5, which have been molded by an existing press, in a direction perpendicular to a longitudinal direction and by welding the cut-off portions thereof to the cut-off portion of the necessary portions of another pressed-type header having been cut off because a tensile force mainly acts on the welded portions. Further, the number of welded portions of the thus obtained longer large header can be reduced as compared with that of the welded-type header according to the conventional example 1 shown in FIG. 4 (the number of the welded portions can be reduced to one position as compared with four positions in the conventional example 1). In addition, since the cut-off portions can be easily welded because they are welded in a circumferential direction (the welding in the circumferential direction can be performed more easily that the welding of the end plates of the conventional example 1).

### BRIEF DESCRIPTION OF THE DRAWINGS

FIGS. 1A to 1C relates to an embodiment 1 of the present invention, wherein FIG. 1A is a perspective view of a header of a plate-fin type heat exchanger, FIG. 1B is a view explaining how a pressed-type header molded by an existing press is cut off, and FIG. 1C is a plan view showing a header manufactured by welding the pressed-type headers, which have been cut off, to each other;

FIGS. 2A to 2C relates to an embodiment 2 of the present invention, wherein FIG. 2A is a perspective view of a header of a plate-fin type heat exchanger, FIG. 2B is a view explaining how a pressed-type header molded by an existing press is cut off, and FIG. 2C is a plan view showing a header manufactured by welding the pressed-type headers, which have been cut off, to each other;

FIG. 3 is an overall perspective view of a typical plate-fin type heat exchanger;

FIG. 4 is a perspective view of a welded-type header according to a conventional example 1; and

FIG. 5 is a perspective view of a pressed-type header according to a conventional example 2.

### DESCRIPTION OF THE PREFERRED EMBODIMENTS

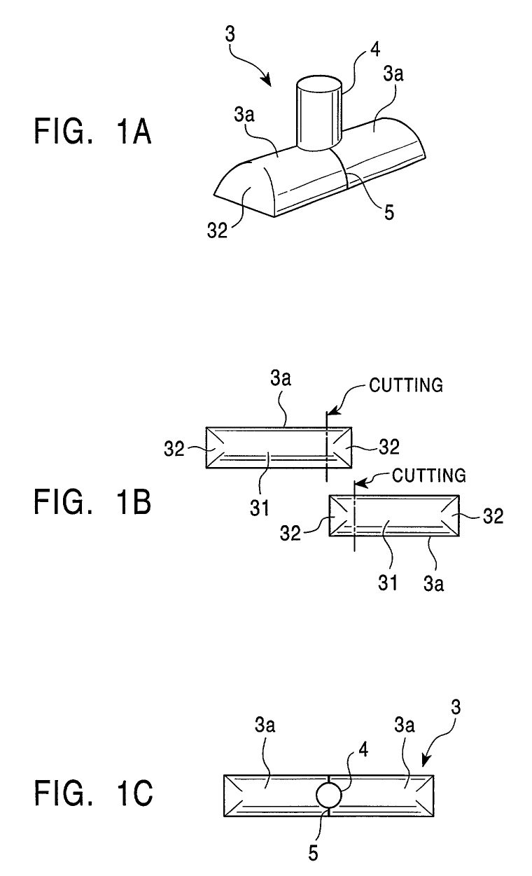

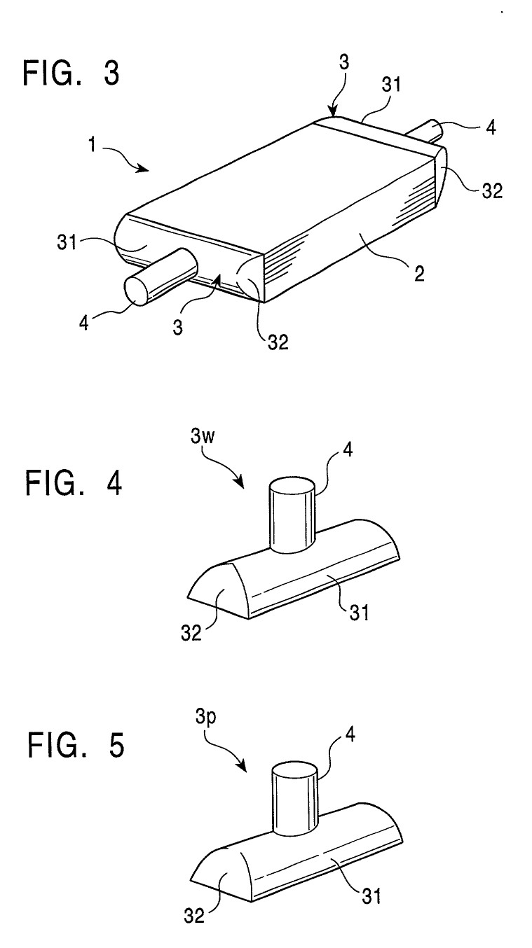

A construction of a plate-fin type heat exchanger according to an embodiment 1 of the present invention will be described below with reference to FIG. 1A which is a perspective view of a header thereof, to FIG. 1B which is a view explaining how a pressed-type header molded by an existing press is cut off, and to FIG. 3 which is a plan view of a header manufactured by welding the pressed-type headers having been cut off to each other. In the above explanation, the components of the embodiment, which are the same as those of the conventional examples or which have the same functions as those of the conventional examples, will be described with reference to the same numerals denoted thereby. However, only the construction of the header will be described here because the embodiment 1 is different from the above conventional examples only in the construction of the header.

Numeral 3 in FIGS. 1A and 1C denotes a header which is constructed such that one-side-cut-off headers 3a, each of which has an end plate 32 at one end of a trough-shaped plate main body 31 and has no end plate 32 at the other thereof, are welded to each other through the ends thereof and a nozzle 4 is welded to the position of the welded portion 5 of the one-side-cut-off headers 3a.

That is, the header 3 of the plate-fin type heat exchanger according to the embodiment 1 is manufactured such that two sets of pressed-shape headers 3p are molded by the existing press, one end sides of the respective pressed-type headers 3p are cut off in directions which are parallel with each other and are perpendicular to the upper surfaces thereof, on which the nozzle 4 is welded, and to the lower end surfaces thereof in a lengthwise direction as shown in FIG. 1B, and the two sets of the longer one-side-cut-off headers 3a that are obtained by being cut off are used as the header 3.

The header 3 of the plate-fin type heat exchanger according to the embodiment 1 is manufactured by welding the two sets of the one-side-cut-off headers 3a, which have been obtained by cutting off one end sides of the pressed-shape headers 3p molded by the existing press, to each other. Accordingly, the size of the header 3 can be very easily increased. Moreover, the header 3 is superior to the welded-type header 3w in pressure resistance because it has such a construction that tensile strength is mainly applied to the welded portion 5 as is understood well by a comparison of FIG. 4 showing the welded-type header 3w according to the conventional example 1 with FIGS. 1A to 1C according to the embodiment. Thus, a large plate-fin type heat exchanger that can be used at high pressure can be manufactured by the employment of the header 3.

Further, the number of welded portions of the header 3 can be reduced more than that of the welded-type header according to the conventional example shown in FIG. 4 (the number of the welded portions can be reduced to one position as compared with four positions in the conventional example 1), whereby the header 3 can be easily welded because it is welded in a circumferential direction (the circumferential welding is easier than the welding of the end plates of the conventional example 1). Further, it is sufficient to weld the nozzle 4 to the header 3 only when it is necessary. When the nozzle 4 is welded as necessary, the selection of the welded portion 5 as the welding position thereof as shown in FIGS. 1A to 1C can achieve a cost reducing effect because the length of the welded portion 5, which must be inspected using radiation is shortened thereby and man-hours necessary for the test can be reduced accordingly, in addition to the above effect.

Incidentally, the length of the shorter cut-off portion obtained by cutting off the pressed-type header 3p molded by the existing press is very short as compared with the overall length of the pressed-shape header 3p. Therefore, according to the embodiment 1, a large header 3 which is almost twice as long as the overall length of the pressed-type header 3p molded by the existing press can be easily obtained.

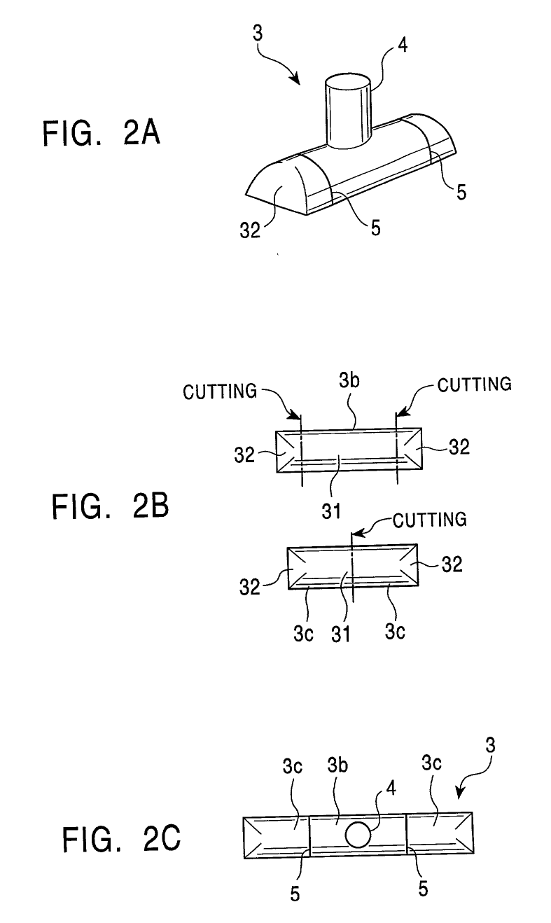

A construction of a plate-fin type heat exchanger according to an embodiment 2 of the present invention will be described below with reference to FIG. 2A which is a perspective view of a header thereof, to FIG. 2B which is a view explaining how a pressed-type header molded by an existing press is cut off and to FIG. 2C which is a plan view of a header manufactured by welding pressed-type headers having been cut off to each other. In the above explanation, the components of the embodiment, which are the same as those of the embodiment 1 or which have the same functions as those of the embodiment 1, will be described with reference to the same numerals denoted thereby. However, only the header will be described here because the embodiment 2 is different from the embodiment 1 only in the construction of the header.

Numeral 3 shown in FIG. 2A denotes the header which is constructed from a both-side-cut-off-header 3b composed only of a trough-shaped plate main body 31 having a nozzle 4 welded to the apex thereof and having no end plate 32 on both the sides thereof and trough-shaped plate main bodies 31, each of which is composed of a portion thereof and an end plate 32 that are molded integrally with each other, abutted against and welded to the ends of the both-side-cut-off-header 3b. That is, the header is manufactured such that two sets of pressed-type headers 3p are molded by the existing press, one of them is cut off at both ends thereof, and the other is cut off at the center thereof as shown in FIG. 2B. Then, as shown in FIG. 2C, the header 3 is manufactured by the both-side-cut-off trough-shaped header 3b which is obtained by cutting off the pressed-type header 3p at both ends thereof and the two sets of the pressed-type half-cut headers 3c that are obtained by cutting off the pressed-type header 3p at the center thereof. Note that while the nozzle 4 is welded to the header 3 in FIGS. 2A to 2C, it is welded as necessary and is not essential, similarly to the embodiment 1.

It is needless to say in the embodiment 2 that the overall length of the header 3 can be optionally adjusted to a necessary size by appropriately changing the length of the pressed-type half-cut headers 3c by further cutting off the cut-off end sides thereof as necessary, and the adjustable range of the overall length of the header 3 is similar to that of the embodiment 1.

Incidentally, while the trough-shaped both-side-cut-off header 3b, which is obtained by cutting off the pressed-type header 3p at both the ends thereof, is used in the embodiment 2, a plate member and a pipe member may be utilized in place of the both-side-cut-off header 3b.

Thus, the header 3 according to the embodiment 2 is manufactured by cutting off the two sets of the pressed-type headers 3p molded by the existing press and welding the thus obtained both-side-cut-off headers 3b to the two sets of the half-cut headers 3c obtained by the cutting-off, similarly to the header according to the embodiment 1, which results in advantages that the number of welded portions is reduced as compared with the number of them of the welded-type header according to the conventional example shown in FIG. 4 (which can be reduced to two positions as compared with four positions in the conventional for example 1) and that the header 3b can be easily welded to the header 3c because they are welded in a circumferential direction (the circumferential welding can be carried out more easily than the welding of the end plates of the conventional example 1).

The length of the welded portions 5 of the header 3 according to the embodiment 3 is shorter than that of the conventional example 1. However, since the length of the welded portions 5 of the header 3 according to the embodiment 2 is about twice as long as that of the header according to the embodiment 1, the embodiment 2 is disadvantageous as compared with the embodiment 1 as to the welding cost of the abutted portions and the cost of an inspection by radiation applied to the welded portions 5. However, the embodiment 2 can obtain the following advantages that cannot be obtained by the embodiment 1.

That is, the header 3 according to the embodiment 2 has such an advantage that the both-side-cut-off header 3b at the central portion, which is obtained by cutting off both the ends of the press-shaped header 3p to which the nozzle 4 is welded, has an appropriate length and many construction members such as various kinds of plate members and pipe members can be combined therewith beforehand, which permits the header 3 to be designed cost-effectively.

Further, in the header 3 according to the embodiment 2, the wall thickness of the both-side-cut-off header 3b can be easily changed from that of the half-cut headers 3c which are welded to the header 3b. When the nozzle 4 must be welded to the header 3, the wall thickness of the header 3 must be increased in the vicinity of the nozzle 4 to secure the area of the opening of the nozzle 4. However, the wall thickness of the both-side-cut-off header 3b, which is located at the central portion and is disadvantageous in strength due to the nozzle 4 welded thereto, can be increased, and thus there can be obtained an effect that the reliability of the vicinity of the portion where the nozzle 4 is welded can be increased.

It should be noted that since the embodiments 1 and 2 are only specific examples of the present invention, the design of them can be optionally changed within a scope which does not depart from the technical spirit of the present invention.

For example, the plate-fin type heat exchanger can be manufactured by the combination of the embodiments 1 and 2. That is, the plate-fin type heat exchanger can be manufactured as described below. To manufacture the plate-fin type heat exchanger, a plurality of headers must be made. Then, one header 5 is manufactured as described in the embodiment 1. In this case, two short portions, which are made by cutting off the pressed-type header 3p, remain. Next, another header 3 is manufactured as shown in the embodiment 2, wherein the two short portions that are cut off by cutting the pressed-type header 3p are utilized as two end components which are to be welded to both the cut ends of the trough-shaped plate main body 31 (as the half-cut press-shaped headers 3c in the example shown in FIG. 2). According to the above construction, the two short portions that remain in the manufacture of one header 3 can be utilized to manufacture another header 3, by which waste and costs can be cut. In this case, a long pipe member, for example, is utilized in the trough-shaped plate main body 31 of the another header 3 to secure the length of the header 3. Thus, no pressed-type header 3p is necessary to manufacture the another header 3, which is cost effective as compared with the header of FIG. 2 which requires two sets of pressed-type headers 3p. In the same way, it is contemplated to utilize both the end components, which remain when the both-side-cut-off header 3b of FIGS. 2A to 2C is manufactured, for the manufacture of the another header 3 similarly to the above case.

As described above, according to the present invention, a header of a plate-fin type heat exchanger is molded by an existing press, and the cut-off portions of a pair of press-shaped headers one end side of each of which in a longitudinal direction is cut off are utilized as end portions. In the present invention, the cut-off portions of a pair of pressed-type headers may be directly welded to each other so that the pressed-type headers are molded integrally with each other. Otherwise, a nozzle may be welded to a welded portion where the cut-off portions of the pair of pressed-type headers are welded to each other.

According to the plate-fin type heat exchanger of the present invention, the size of the header can be very easily increased, and further, a tensile force mainly acts on the welded portion, different from the welded portion of the welded-type header of the conventional example 1, and thus the header of the present invention is superior to the welded-type header in pressure resistance, which permits a large plate-fin type heat exchanger that can be used at high pressure to be easily manufactured.

Further, the number of the welded portions of the plate-fin type heat exchanger of the present invention can be reduced as compared with that of the welded-type header according to the conventional example 1 (the number can be reduced to one position as compared with four positions of the conventional example 1). Further, the plate-fin type heat exchanger of the present invention can be easily welded because it is welded in a circumferential direction (the circumferential welding can be more easily carried out than the welding of the end plates of the conventional example 1). In addition to the above, since the man-hours necessary to test the welded portions using radiation wave can be reduced, a cost reduction effect can be achieved by the reduction of a cost necessary to test the welded portions.

According to the present invention, a header of a plate-fin type heat exchanger may be constructed integrally such that the cut-off portions of a press-shaped header molded by an existing press are welded to the respective ends of a trough-shaped plate main body formed in a mountain-like shape, and further, a nozzle may be welded to the trough-shaped plate main body.

Accordingly, the plate-fin type heat exchanger of the present invention has such an advantage that many construction members such as various types of plate members and pipe members can be combined beforehand with the central portion of the heat exchanger that is obtained by cutting off both the ends of the press-shaped header because the central portion has an appropriate length in advance and the head can be designed cost effectively, in addition to the above-mentioned advantages. Further, the wall thickness of the central portion that is obtained by cutting off both the ends of the press-shaped header can easily be changed from that of other press-shaped headers to be welded to the ends of the central portion so that the wall thickness of the central portion which is made disadvantageous in strength by the nozzle welded thereto can be increased, by which an advantage can be obtained in that the plate members and the pipe members can be utilized in place of a both-side-cut-off header, in addition to the advantage that the reliability of the vicinity of the portion where the nozzle is welded can be easily increased.

What is claimed is:

1. A plate-fin type heat exchanger comprising:
a core having a plate-fin and side bars interposed between partitions; and
a header welded to said core, said header including a pair of ends that are formed by cutting off press-shaped headers in a direction perpendicular to a longitudinal direction.

2. A plate-fin type heat exchanger according to claim 1, wherein said header is constructed by welding the cut-off portions of said pair of ends to each other.

3. A plate-fin type heat exchanger according to claim 1, further comprising a nozzle welded to said header and welded to a welded portion where said cut-off portions of said pair of ends are welded to each other.

4. A plate-fin type heat exchanger according to claim 1, wherein said header comprises said pair of ends and a trough-shaped plate both the ends of which are welded to said pair of ends.

5. A plate-fin type heat exchanger according to claim 4, further comprising a nozzle welded to said trough-shaped plate.
